(19) United States
(12) Patent Application Publication
(10) Pub. No.: US 2019/0313257 A1
(43) Pub. Date: Oct. 10, 2019

(54) SYSTEM AND METHOD FOR CONTROLLING ACCESS TO IMAGE INFORMATION

(71) Applicants: HYUNDAI MOTOR COMPANY, Seoul (KR); KIA MOTORS CORPORATION, Seoul (KR)

(72) Inventors: Hyun-Sang KIM, Hwaseong-Si (KR); Dong-Woo KIM, Hwaseong-Si (KP); Dong-Hyuk JEONG, Hwaseong-Si (KR)

(21) Appl. No.: 16/205,775

(22) Filed: Nov. 30, 2018

(30) Foreign Application Priority Data
Apr. 6, 2018 (KR) 10-2018-0040439

(51) Int. Cl. H04W 12/08; H04N 5/775; H04L 29/06; H04W 12/06; G06F 21/60

(52) U.S. Cl. CPC H04W 12/08; H04N 5/775; G06F 21/604; H04W 12/06; H04L 63/0861

(57) ABSTRACT

A system for controlling access to image information may include a navigation terminal configured to perform a wireless communication establishment with a communication terminal by detecting a signal from the communication terminal registered in advance, and an image information controller configured to provide access authority with respect to image information when the wireless communication establishment is completed.

### CROSS-REFERENCE TO RELATED APPLICATION

This application claims priority to Korean Patent Application No. 10-2018-0040439 filed on Apr. 6, 2018, which is incorporated herein by reference in its entirety.

### TECHNICAL FIELD

Exemplary embodiments of the present disclosure relate to a drive video recording system installed at a vehicle. More particularly, exemplary embodiments of the present disclosure relate to a system and a method for controlling access to image information in a drive video recording system for a vehicle.

### BACKGROUND

Recently, a drive video recording system configured with a black box for storing an image during accident and a navigation is generally installed at a vehicle. In the case of valet parking, since no separate security or blocking function for another driver is present, access to a file of the drive video recording system is permitted. Therefore, in the case of malicious intent, there may be a concern that data is deleted or damaged.

In order to prevent the foregoing, it is necessary to recognize a valet parking situation and take appropriate measures in the valet parking situation, and a preventive method capable of automatically blocking unauthorized access is disclosed.

An example of such a preventive method includes a method of allowing only a vehicle owner to access a file of a drive video recording system by requiring entry of a password. In this case, however, there is cumbersomeness for the vehicle owner to enter the password whenever accessing to the drive video recording system.

Further, when the vehicle owner forgets the password, there is a disadvantage in that the vehicle owner cannot access to the drive video recording system. Furthermore, initializing of the password is possible by resetting the drive video recording system by a service center, but there is a concern that stored data may be deleted.

### SUMMARY

An embodiment of the present disclosure is directed to a system and a method for controlling access to image information, which are capable of blocking unauthorized access except for a vehicle owner during valet parking.

Further, an embodiment of the present disclosure is directed to a system and a method for controlling access to image information, which are capable of allowing a vehicle owner to access to a menu of a drive video recording system only when the vehicle owner possesses a communication terminal and then boards a vehicle.

Furthermore, an embodiment of the present disclosure is directed to a system and a method for controlling access to image information, which are capable of being automatically set to allow confirmation and deletion of a stored image and a system setting.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

Provided herein are a system and a method for controlling access to image information, which are capable of blocking unauthorized access except for a vehicle owner during valet parking.

In accordance with an embodiment of the present disclosure, a system for controlling access to image information includes a navigation terminal configured to perform a wireless communication establishment with a communication terminal by detecting a signal from the communication terminal registered in advance, and an image information controller configured to provide access authority with respect to image information when the wireless communication establishment is completed.

The image information controller may include a processor configured to cause a memory to store the image information and manage the image information, and an access control module configured to control access to the image information according to the access authority.

The image information controller may include a sensor for detecting an external impact.

The wireless communication establishment may be completed through signal detection and pairing between the communication terminal and the navigation terminal.

The image information controller may generate an output screen of the navigation terminal.

The image information controller may output guidance information when a communication terminal does not correspond to the communication terminal registered in advance.

Meanwhile, the system for controlling access to image information may further include a driving state warning controller configured to recognize a face of a driver through facial image information of the driver when starting and determine whether the driver is a preset authorized user.

The system for controlling access to image information may further include a fingerprint authentication controller configured to recognize a fingerprint of a driver through fingerprint information of the driver when starting and determine whether the driver is a preset authorized user.

The access authority may be at least one of a system environment setting, a file playback, a file deletion, a file download, and a file search.

The image information may be generated by a front camera and a rear camera of the vehicle.

In accordance with another embodiment of the present disclosure, a method for controlling access to image information includes a communication establishment performing operation of performing, by a navigation terminal, wireless communication establishment with a communication terminal, which is registered in advance, by detecting a signal from the communication terminal, and when the wireless communication establishment is completed, an access authority providing operation of providing, by an image information controller, access authority with respect to image information.

The access authority providing operation may include causing, by a processor, a memory to store the image information and managing the image information, and controlling, by an access control module, access to the image information according to the access authority.

The access authority providing operation may further include detecting, by the image information controller, an external impact.

The access authority providing operation may further include outputting, by the image information controller, guidance information when a communication terminal does not correspond to the communication terminal registered in advance.

The access authority providing operation may further include recognizing, by a driving state warning controller, a face of a driver through facial image information of the driver when starting and determining whether the driver is a preset authorized user.

The access authority providing operation may include recognizing, by a fingerprint authentication controller, a fingerprint of a driver through fingerprint information of the driver when starting and determining whether the driver is a preset authorized user.

### BRIEF DESCRIPTION OF THE DRAWINGS

FIG. 1A is a block diagram of a configuration of a system for controlling access to image information according to one embodiment of the present disclosure.

FIG. 1B is a block diagram of a configuration of a navigation terminal shown in FIG. 1A.

FIG. 2 is an example of configuring an additional security function in the system for controlling access to image information shown in FIG. 1A.

FIG. 3 is a flowchart illustrating a process of controlling access to image information according to one embodiment of the present disclosure.

FIG. 4 is a flowchart illustrating a process of controlling access to image information according to another embodiment of the present disclosure.

### DETAILED DESCRIPTION

The present disclosure may be modified into various forms and may have a variety of embodiments, and, therefore, specific embodiments will be illustrated in the drawings and described in detail. The embodiments, however, are not to be taken in a sense which limits the present disclosure to the specific embodiments, and should be construed to include modifications, equivalents, or substitutes within the spirit and technical scope of the present disclosure.

In describing each drawing, similar reference numerals are assigned to similar components. Although the terms “first,” “second,” and the like may be used herein to describe various components, these components should not be limited by these terms. The terms are used only for the purpose of distinguishing one component from another component.

For example, without departing from the scope of the present disclosure, a first component may be referred to as a second component, and similarly, a second component may also be referred to as a first component. The term “and/or” includes a combination of a plurality of related listed items or any item of the plurality of related listed items.

Unless otherwise defined, all terms including technical or scientific terms used herein have the same meaning as commonly understood by those skilled in the art to which the present disclosure pertains.

General terms that are defined in a dictionary shall be construed to have meanings that are consistent in the context of the relevant art and should not be interpreted as having an idealistic or excessively formalistic meaning unless clearly defined in this disclosure.

Hereinafter, a system and a method for controlling access to image information according to embodiments of the present disclosure will be described in detail with reference to the accompanying drawings.

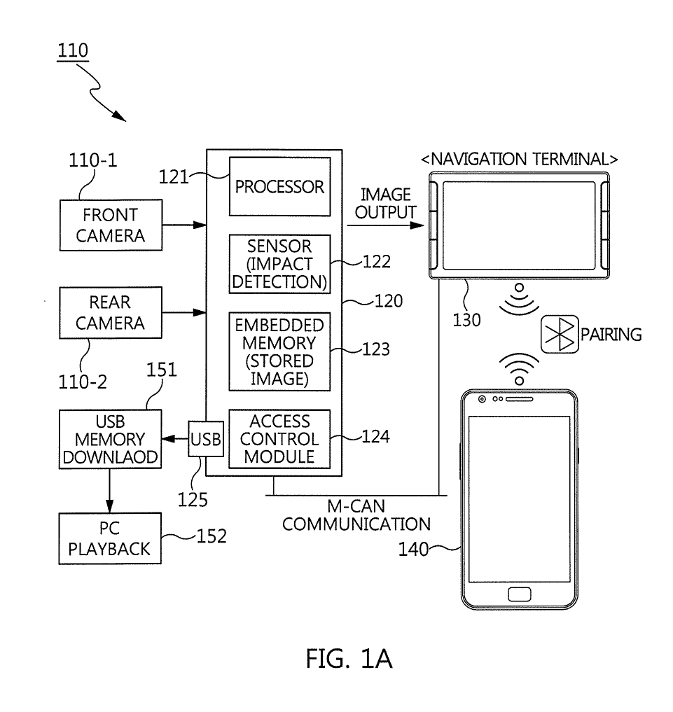

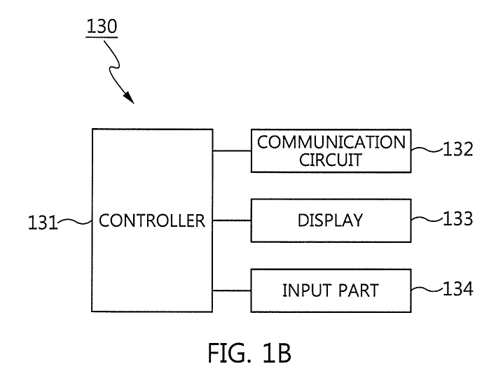

FIG. 1A is a block diagram of a configuration of a system 110 for controlling access to image information according to one embodiment of the present disclosure. Referring to FIG. 1A, the system 110 for controlling access to image information may be configured to include cameras 110-1 and 110-2 for generating image information, an image information controller 120 configured to provide the image information and access authority for the image information, a navigation terminal 130 configured to output the image information, and a communication terminal 140 configured to perform wireless communication establishment with the navigation terminal 130.

The cameras 110-1 and 110-2 are configured with a front camera 110-1 and a rear camera 110-2 which are installed in front of a vehicle. The front and rear cameras 110-1 and 110-2 take images to generate image information. The front and rear cameras 110-1 and 110-2 may include a closed circuit television (CCTV), a charge-coupled device (CCD) camera, a complementary metal-oxide semiconductor (CMOS) camera, or the like.

The image information controller 120 serves to provide access authority for the image information when wireless communication is established. The image information controller 120 is installed at a center console (not shown) of the vehicle to collectively control the overall system. Further, the image information controller 120 stores the image information in a memory 123.

In addition, the image information controller 120 is configured to include a processor 121 configured to manage the image information, and an access control module 124 configured to control access to the image information according to the access authority.

When an impact is detected by a sensor 122, the image information controller 120 stores images received from the front and rear cameras 110-1 and 110-2 in the memory 123 embedded in the image information controller 120 and manages a file. The sensor 122 may include a gyro sensor, a fiber bragg grating (FBG) sensor, or the like so as to detect an impact.

The memory 123 may include at least one type of storage medium from among a flash type memory, a hard disk type memory, a multimedia card micro type memory, a card type memory (e.g., a secure digital (SD) or extreme digital (XD) memory), a random access memory (RAM), a static random access memory (SRAM), a read only memory (ROM), an electrically erasable programmable read only memory (EEPROM), a programmable read only memory (PROM), a magnetic memory, a magnetic disk, and an optical disk. Alternatively, the memory 123 may be operated in association with a web storage or a cloud server which performs a storage function of the memory 123 on the Internet.

When the communication terminal 140 belongs to a vehicle owner and communication establishment, such as pairing between the communication terminal 140 and the navigation terminal 130, is completed, the access control module 124 performs a function of granting access authority to a user of the communication terminal 140 with respect to the image information stored in the memory 123. Examples of the access authority may include a system environment setting, a file playback, a file deletion, a file download, a file search, and the like. Accordingly, image information may be output through the navigation terminal 130. Further, the image information of the memory 123 may be downloaded into a universal serial bus (USB) memory 151 through a USB port 125. Accordingly, the user may playback the image information on a communication device 152 such as a personal computer (PC) or the like.

The term “˜ module” used herein means a unit for processing at least one function or operation, and this unit may be implemented by hardware, software, or a combination of hardware and software. The hardware may be implemented with an application specific integrated circuit (ASIC) designed to perform the above-described functions, a digital signal processor (DSP), a programmable logic device (PLD), a field programmable gate array (FPGA), a processor, a controller, a microprocessor, another electronic unit, or a combination thereof. The software may be implemented with a module for performing the above-described functions. The software may be stored in a memory (transitory or non-transitory) and may be executed by a processor. The memory or the processor may employ various parts well known to those skilled in the art.

The navigation terminal 130 is connected to the image information controller 120 through multimedia-controller area network (M-CAN) communication and exchanges signals with the image information controller 120. Particularly, the navigation terminal 130 registers the communication terminal 140 by performing a registration procedure in advance and stores terminal information of the communication terminal 140. In addition to the M-CAN communication, for the purpose of communication between the navigation terminal 130 and the image information controller 120, a body-controller area network (B-CAN), a high-speed CAN, a communication line (e.g., 500 kbps), a CAN-flexible data (FD)-rate communication line, a flexlay communication line, a local interconnect network (LIN) communication line, a power line communication (PLC) communication line, a control pilot (CP) communication line, and the like may be used.

The communication terminal 140 is a communication device capable of communicating with the navigation terminal 130. For example, the communication terminal 140 may include a mobile phone, a smart phone, a laptop computer, a digital broadcasting terminal, a personal digital assistant (PDA), a portable multimedia player (PMP), and the like.

Bluetooth communication is mainly used as the communication between the communication terminal 140 and the navigation terminal 130, but the present disclosure is not limited thereto. In addition to the foregoing, wireless fidelity (WiFi), a high speed downlink packet access (HSDPA) network, a near field communication (NFC), and the like may be used.

FIG. 1B is a block diagram of a configuration of the navigation terminal 130 shown in FIG. 1A. Referring to FIG. 1B, the navigation terminal 130 may be configured to include a controller 131 configured to entirely control the navigation terminal 130, a communication circuit 132 configured to communicate with the communication terminal 140 and/or the image information controller 120 with wireless and/or wired communication, a display 133 configured to output image information, and an input part 134 configured to receive a user command.

The controller 131 performs wireless communication establishment with the communication terminal 140 by detecting a signal from the communication terminal 140 and transmits an operation permission to the image information controller 120 according to the result of the wireless communication establishment. Alternatively, the controller 131 performs pairing only when a signal is received from a registered communication terminal 140 and when a signal is received from an unregistered communication terminal 140, the controller 131 does not perform pairing. Particularly, when a signal is received from the unregistered communication terminal 140, the controller 131 may transmit the received signal to the image information controller 120. To this end, the controller 131 may be configured with a microprocessor, a memory, and/or the like.

The communication circuit 132 performs wireless and/or wired communication with the communication terminal 140 and/or the image information controller 120. Therefore, a circuit for wired communication and a circuit for wireless communication are constituted.

The display 133 outputs image information, a system environment setting screen, a menu screen for registering the communication terminal 140 in advance, and the like. The display 133 may include a liquid crystal display (LCD), a light emitting diode (LED) display, an organic LED (OLED) display, a touch screen, a flexible display, or the like.

The input part 134 serves to receive a user command. To this end, several buttons may be provided. Alternatively, a microphone for a voice input may be used. When the display 133 is a touch screen, the input part 134 may be used by being replaced with the touch screen.

A drive video recording system icon is provided at the navigation terminal 130, and thus an operation mode may be executed through the drive video recording system icon. The drive video recording system icon may be a physical button or an icon on a program displayed on a screen.

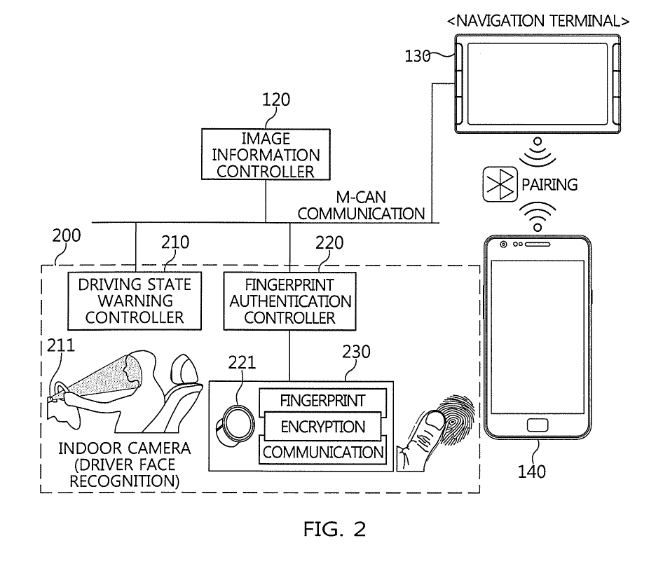

FIG. 2 is an example of configuring an additional security function in the system 100 for controlling access to image information shown in FIG. 1A. Referring to FIG. 2, the system 110 for controlling access to image information further includes a driving state warning controller 210 configured to recognize a face of a driver through driver facial image information when starting and determine whether the driver is a preset authorized user, and a fingerprint authentication controller 220 configured to recognize a fingerprint of the driver through driver fingerprint information when starting and determine whether the driver is a preset authorized user.

The driving state warning controller 210 compares a facial shape of a current driver, which is taken using an indoor camera 211 installed inside the vehicle, with a preset reference face image and determine whether the current driver is an authorized driver. That is, only when a person sitting on a driver seat is a vehicle owner, access to the system 110 for controlling access to image information is allowed.

Further, the fingerprint authentication controller 220 compares fingerprint information of the current driver, which is obtained through a fingerprint acquisition terminal 230, with preset reference fingerprint information and determines whether the current driver is an authorized driver. That is, only when a person sitting on a driver seat is a vehicle owner, access to the system 110 for controlling access to image information is allowed.

The fingerprint acquisition terminal 230 constitutes a fingerprint recognition function at a start button 221. Accordingly, the driver possesses a smart key and presses the start button 221 to start the vehicle. Therefore, it is possible to determine whether the driver is the vehicle owner using the fingerprint information recognized when the driver presses the start button 221.

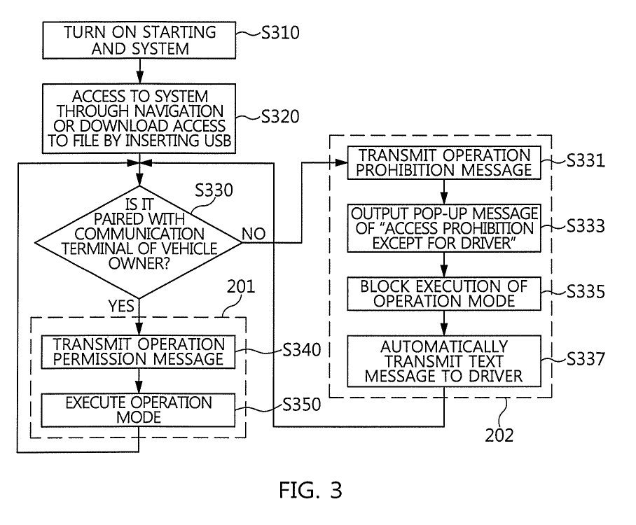

FIG. 3 is a flowchart illustrating a process of controlling access to image information according to one embodiment of the present disclosure. Referring to FIG. 3, when starting of the vehicle is turned on and the system 100 for controlling access to image information of FIG. 1 is also turned on, a driver performs access through the navigation terminal 130 or perform download access to a file by inserting the USB memory 151 (S310 and S320).

As such access is performed, whether the navigation terminal 130 is paired with the communication terminal 140 (S330). As the determination result, when pairing is established between the navigation terminal 130 and the communication terminal 140 of the vehicle owner, an operation mode execution block 201 is performed.

When the pairing is established between the navigation terminal 130 and the communication terminal 140 in the operation mode execution block 201, the navigation terminal 130 transmits an operation permission message to the image information controller 120 of FIG. 1 (S340).

Thereafter, when the image information controller 120 receives the operation permission message from the navigation terminal 130, an operation mode is executed (S350). That is, in this operation mode, the driver may perform a system environment setting, a file playback, a file deletion, a file download, and a file search by receiving access authority with respect to image information.

Otherwise, in the operation S330, when the pairing is not established between the navigation terminal 130 and the communication terminal 140 of the vehicle owner, an operation mode blocking block 202 is performed to block execution of the operation mode.

When the pairing is not established between the navigation terminal 130 and the communication terminal 140 in the operation mode blocking block 202, the navigation terminal 130 transmits an operation prohibition message to the image information controller 120 of FIG. 1 (S331). Alternatively, the navigation terminal 130 may determine only whether the pairing is established, and the image information controller 120 may determine whether the operation of the navigation terminal 130 is prohibited. In this case, the image information controller 120 has registration information on the navigation terminal 130 in advance.

Thereafter, the image information controller 120 outputs a pop-up message of “access prohibition except for driver” on a screen of the navigation terminal 130 and blocks execution of the operation mode (S333 and S335).

Then, the image information controller 120 automatically transmits a guidance message, such as a text message, to the communication terminal 140 of the driver (S337). Alternatively, in addition to texts, a combination of voices, graphics, and characters may be transmitted to the communication terminal 140 of the driver.

In other words, only when the communication terminal 140 of the vehicle owner is present inside the vehicle and Bluetooth pairing is automatically detected using Bluetooth communication applied to the navigation terminal 130, a current driver of the vehicle is allowed to access to the image information through the navigation terminal 130 or a UBS. In the case of valet parking, since the communication terminal 140 of the vehicle owner is absent, the vehicle owner is determined as being absent and thus access to the image information is blocked.

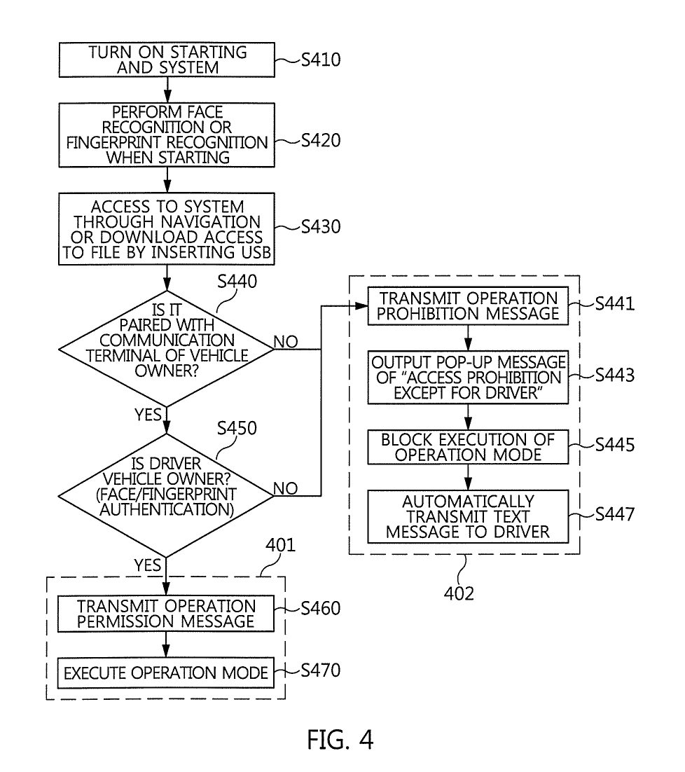

FIG. 4 is a flowchart illustrating a process of controlling access to image information according to another embodiment of the present disclosure. Referring to FIG. 4, when starting of the vehicle is turned on and the system 100 for controlling access to image information of FIG. 1 is also turned on, face recognition or fingerprint recognition is performed, and a driver performs access through the navigation terminal 130 or perform download access to a file by inserting the USB memory 151 (S410, S420, and S430).

As such access is performed, whether the navigation terminal 130 is paired with the communication terminal 140 (S440). As the determination result, when pairing is established between the navigation terminal 130 and the communication terminal 140 of the vehicle owner, whether the driver is a vehicle owner is determined (S450). That is, whether the driver is an authorized driver is determined using information obtained through the face recognition or the fingerprint recognition.

As the determination result, when the driver is determined as being the vehicle owner, an operation mode execution block 401 is performed.

When the pairing is established between the navigation terminal 130 and the communication terminal 140 in the operation mode execution block 401, the navigation terminal 130 transmits an operation permission message to the image information controller 120 of FIG. 1 (S460).

Thereafter, when the image information controller 120 receives the operation permission message from the navigation terminal 130, an operation mode is executed (S470).

Otherwise, when the pairing is not established between the navigation terminal 130 and the communication terminal 140 of the vehicle owner in the operation S440 or the current driver is determined as not being the vehicle owner in the operation S450, an operation mode blocking block 402 is performed to block execution of an operation mode.

When the pairing is not established between the navigation terminal 130 and the communication terminal 140 in the operation mode blocking block 402, the navigation terminal 130 transmits an operation prohibition message to the image information controller 120 of FIG. 1 (S441).

Thereafter, the image information controller 120 outputs a pop-up message of “access prohibition except for driver” on a screen of the navigation terminal 130 and blocks execution of the operation mode (S443 and S445).

Then, the image information controller 120 automatically transmits a guidance message, such as a text message, to the communication terminal 140 of the driver (S447).

In accordance with the present disclosure, there is an effect in that it is possible to prevent access of a driver except for a vehicle owner in a valet parking situation and the like, such that damage and/or extortion of an accident record can be prevented.

Further, in accordance with the present disclosure, there is another effect in that there is no concern for forgetting of a password and it is possible to reduce cumbersomeness inconvenience of entering the password whenever accessing.

Furthermore, in accordance with the present disclosure, there is still another effect in that security of a drive video recording system can be enhanced in a valet parking situation by interlocking with a smart phone of the vehicle owner as well as by additionally interlocking with a face recognition function, a fingerprint recognition function, and the like.

The valet packing as described above is an example to prevent access of a driver except for a vehicle owner when the vehicle owner is absent; the present disclosure, however, is not limited to this particular example.

Further, the operations of the method or algorithm described in connection with the embodiments disclosed herein may be implemented in the form of a program command which is executable through various computer means such as a microprocessor, processor, and CPU, and may be recorded in a computer-readable non-transitory, or transitory, medium. The computer-readable medium may include program (command) codes, data files, data structures, and the like in alone or a combination thereof.

The program (command) codes recorded in the computer-readable medium may be specially designed and configured for the embodiment or may be available to those skilled in the computer software. Examples of the computer-readable recording medium may include magnetic media such as a hard disk, a floppy disk, a magnetic tape, and the like, optical media such as a compact disc read only memory (CD-ROM), a digital versatile disc (DVD), a blue-ray disc, and the like, and semiconductor memory devices, which are specifically configured to store and execute program (command) codes, such as a ROM, a RAM, a flash memory, and the like.

Here, examples of the program (command) codes include machine language codes generated by a compiler, as well as high-level language codes which are executable by a computer using an interpreter or the like. The above-described hardware devices may be configured to operate as one or more software modules so as to perform an operation of the present disclosure, and vice versa.

What is claimed is:

1. A system for controlling access to image information, comprising:
a navigation terminal configured to perform a wireless communication establishment with a communication terminal by detecting a signal from the communication terminal registered in advance in a state; and
an image information controller configured to provide access authority with respect to image information when the wireless communication establishment is completed.

2. The system of claim 1, wherein the image information controller includes:
a processor configured to cause a memory to store the image information and manage the image information; and
an access control module configured to control access to the image information according to the access authority.

3. The system of claim 1, wherein the image information controller includes a sensor for detecting an external impact.

4. The system of claim 1, wherein the wireless communication establishment is completed through signal detection and pairing between the communication terminal and the navigation terminal.

5. The system of claim 1, wherein the image information controller generates an output screen of the navigation terminal.

6. The system of claim 1, wherein the image information controller outputs guidance information when a communication terminal does not correspond to the communication terminal registered in advance.

7. The system of claim 1, further comprising:
a driving state warning controller configured to recognize a face of a driver through facial image information of the driver when starting and determine whether the driver is a preset authorized user.

8. The system of claim 1, further comprising:
a fingerprint authentication controller configured to recognize a fingerprint of a driver through fingerprint information of the driver when starting and determine whether the driver is a preset authorized user.

9. The system of claim 1, wherein the access authority is at least one of a system environment setting, a file playback, a file deletion, a file download, and a file search.

10. The system of claim 1, wherein the image information is generated by a front camera and a rear camera of the vehicle.

11. A method for controlling access to image information, comprising:
a communication establishment performing operation of performing, by a navigation terminal, wireless communication establishment with a communication terminal, which is registered in advance, by detecting a signal from the communication terminal; and
when the wireless communication establishment is completed, an access authority providing operation of providing, by an image information controller, access authority with respect to image information.

12. The method of claim 11, wherein the access authority providing operation includes:
causing, by a processor, a memory to store the image information and managing the image information; and
controlling, by an access control module, access to the image information according to the access authority.

13. The method of claim 11, wherein the access authority providing operation includes detecting, by the image information controller, an external impact.

14. The method of claim 11, wherein the wireless communication establishment is completed through signal detection and pairing between the communication terminal and the navigation terminal.

15. The method of claim 11, further comprising:
generating, by the image information controller, an output screen of the navigation terminal.

16. The method of claim 11, wherein the access authority providing operation includes outputting, by the image information controller, guidance information when a communication terminal does not correspond to the communication terminal registered in advance.

17. The method of claim 11, wherein the access authority providing operation includes recognizing, by a driving state warning controller, a face of a driver through facial image information of the driver when starting and determining whether the driver is a preset authorized user.

18. The method of claim 11, wherein the access authority providing operation includes recognizing, by a fingerprint authentication controller, a fingerprint of a driver through fingerprint information of the driver when starting and determining whether the driver is a preset authorized user.

19. The method of claim 11, wherein the access authority is at least one of a system environment setting, a file playback, a file deletion, a file download, and a file search.
